(19) United States
(12) Patent Application Publication
(10) Pub. No.: US 2017/0267499 A1
(43) Pub. Date: Sep. 21, 2017

(54) LIFTING MECHANISM AND LIFTING DEVICE COMPRISING IT

(71) Applicant: AH INDUSTRIES A/S, Riber (DK)

(72) Inventor: Allan Leth Frank, Kolding (DK)

(21) Appl. No.: 15/604,293

(22) Filed: May 24, 2017

Related U.S. Application Data
(63) Continuation of application No. PCT/DK2015/050357, filed on Nov. 20, 2015.

(30) Foreign Application Priority Data
Nov. 27, 2014 (DK) 20140000690

(51) Int. Cl. B66C 1/10; B66C 13/08

(52) U.S. Cl. CPC B66C 1/108; B66C 13/08

(57) ABSTRACT

A lifting mechanism (2) for lifting an object (46) is disclosed. The lifting mechanism (2) comprises drive means (4, 54) comprising means (10, 52, 50, 56) for being attached to a frame (20) of a lifting device, e.g. a yoke (42). The lifting mechanism (2) further comprises a lifting member (38) provided with means for being connected to a wire (32). The lifting mechanism (2) comprises means for moving the lifting member (38) in an arched movement path (40) relative to the frame (20) when the lifting mechanism (2) is attached to the frame (20), wherein the lifting mechanism (2) is configured to be suspended in only one lifting point (28).

### FIELD OF INVENTION

The present invention generally relates to an apparatus configured to be handled by a lifting apparatus such as a crane. The present invention more particularly relates to a lifting mechanism configured to pitch and/or tilt a load and a lifting device comprising the lifting mechanism.

### PRIOR ART

Various lifting mechanisms have been described for lifting wind turbine blades. The patent application WO2010124744A1 describes a method and a yoke for lifting wind turbine blades. While the yoke allows for receiving and maintaining a wind turbine blade in a fixed position within the yoke, it is not suitable for pitching the wind turbine blade.

Therefore, when a yoke like the one disclosed in WO2010124744A1 is use to install wind turbine blades, it is necessary to use another strategy in order to pitch the yoke when this is required. Pitching the yoke may be done by means of a crane and a plurality of wires by varying the length of a part of the wires. This solution is difficult to practice and requires plenty of space and thus a large lifting height.

DK177338B1 describes a lifting device for handling wind turbine blades. The lifting device comprises a connection arrangement configured to pitch the lifting device. The lifting device comprises an actuator that is rotatably attached to the frame of the connection arrangement and rotatably attached to a yoke of the lifting device.

The actuator is, however, only suitable for pitching the lifting device within a limited range of motion as the required extension rate depends heavily on the pitch angle of the lifting device.

This means that in order to provide a given pitch change when the pitch angle is gradually changed from the point at which the actuator has its shortest length, the actuator needs to extend further and further. Moreover, the lifting device disclosed can only pitch the lifting device in the pitching direction relative to the connection arrangement due to the construction.

US2012032125A1 discloses a device for handling a rotor blade of a wind turbine. The device includes a frame defining an inner space for at least partially accommodating the rotor blade. The device further includes a blade support which is arranged in the inner space and mounted to the frame, and a first lever arm. The first lever arm is pivotably mounted to the frame and includes a retaining end arranged in the inner space and an actuator end which is movable to rotate the first lever arm so that the rotor blade is retained between the blade support and the retaining end. The device is, however, suspended in two separate points. Accordingly, two wire members are mechanically connected to these points and an upper suspension point attached to a lifting unit.

Accordingly, this device requires a lifting device that can provide an upper suspension point in a distance above the device. Therefore, a large lifting height is required.

Thus, there is a need for a lifting mechanism and a lifting device which reduce or even eliminate the above-mentioned disadvantages of the prior art and enables an easy pitch or tilt procedure applicable in lifting mechanisms and lifting devices configured to handle large objects such as wind turbine blades in a manner in which the lifting height can be reduced compared with the known solutions.

Accordingly, it is an object of the present invention to provide a lifting mechanism and a lifting device capable of performing the required pitch or tilt procedure in an easier and more reliable manner than the prior art lifting devices and in a manner in which the lifting height can be reduced compared with the known solutions.

### SUMMARY OF THE INVENTION

The object of the present invention can be achieved by a lifting mechanism as defined in claim 1 and by a lifting device as defined in claim 9. Preferred embodiments are defined in the dependent sub claims, explained in the following description and illustrated in the accompanying drawings.

The device according to the invention is a lifting mechanism for lifting an object, which lifting mechanism comprises drive means comprising means for being attached to a frame of a lifting device (e.g. a yoke).The lifting mechanism further comprises a lifting member provided with means for being connected to a wire, wherein the lifting mechanism comprises means for moving the lifting member in an arched or curved movement path relative to the frame when the lifting mechanism is attached to the frame, wherein the lifting mechanism is configured to be suspended in only one lifting point.

Hereby, it is possible to perform the required pitch or tilt procedure in an easy manner e.g. when handling wind turbine blades.

The device according to the invention is a lifting mechanism for lifting objects such as wind turbine blades. However, the device may be used to handle various other objects.

The drive means may be any type of suitable drive members including electrical and hydraulic actuators or members configured to provide a rotation or a rotational motion of one or more components.

It may be an advantage that the lifting mechanism comprises a control unit (e.g. a control box) equipped with means for controlling the drive means.

It may be preferred that the control unit comprises means, such as a wireless receiving module, allowing it to be wirelessly controlled by e.g. a remote control base on any suitable wireless communication technology, e.g. a radio frequency technology.

The drive means comprises means for being attached to the frame of a yoke. These means may be of any suitable type, size and geometry. The drive means may be movably, slidably or rotatably arranged to or coupled to a member that is integrated into or attached to the frame of a yoke. Alternatively, the drive means may be attached to the frame by mounting members, bolts or any other means providing a fixed attachment of the drive means to the frame.

The lifting mechanism further comprises a lifting member provided with means for being connected to a wire or to the hook member of a wire.

The lifting member may comprise a plate member provided with an aperture or bore for attachment of a wire or the hook member of a wire. The lifting member may comprise a plate member that is rotatably attached to a connection member being or comprising means for being rotably attached to the frame.

The lifting mechanism comprises means for moving the lifting member in an arched or curved movement path relative to the frame when the lifting mechanism is attached to the frame. The arched or curved movement path may be circular or elliptic.

In this manner, it is possible to provide a large angular range of motion in limited space. Moving the lifting member causes displacement of the lifting point relative to the centre of gravity. This displacement of the lifting point introduces a torque and hereby a rotation of the lifting mechanism and the frame that it is attached to.

It may be an advantage that the lifting mechanism comprises means for moving the lifting member in an arched or curved movement path relative to the frame when the lifting mechanism is attached to the frame, where the arched or curved movement path is a circular arched curve or an elliptic curve.

It may be preferred that the lifting mechanism comprises means for moving the lifting member in an arched movement path relative to the frame when the lifting mechanism is attached to the frame, where the lifting point is moved about the centre of gravity along a basically circular path.

Hereby, it is achieved that the distance between the centre of gravity and the lifting point is maintained constant upon activation of the drive means. This is a major advantage compared with the prior art in which the distance between the center of gravity and the lifting point varies significantly during activation of the drive means.

It may be an advantage that the lifting mechanism comprises mechanical connection means provided between the drive means and the lifting member, and that these mechanical connection means are constructed in such a manner that the lifting member, upon activation of the drive means, is moved in an arched movement path relative to the frame when the lifting mechanism is attached to the frame.

Hereby, it is possible to apply a simple actuator, e.g. a linear actuator to create motion along a straight line and transform this linear motion to a motion that causes the lifting member to be moved in an arched movement path. It is possibly to make a simple rotation device configured to cause the lifting member to be moved in an arched/curved/elliptic movement path. The mechanical connection means may be of any suitable type and size.

It may be advantageous that the lifting mechanism comprises means for, upon activation of the drive means, moving the lifting member in an arched movement path relative to the frame when the lifting mechanism is attached to the frame. Hereby, it is possible to provide the required movement path in a simple and secure manner.

It may be beneficial that the lifting mechanism comprises a rod member, a slide member, an attachment member, a connection member and an actuator having a rod member, where the attachment member is fixed to the connection member that is mechanically attached to the slide member being slidably attached to the rod member extending basically parallel to the rod member of the actuator.

Hereby, it is possible to provide a solid and reliable construction easy to scale and mount on a yoke.

It may be advantageous that the lifting mechanism comprises a rack, a pinion and a connection member, where the rack is provided with a plurality of teeth configured to engage with the teeth of the pinion that is rotatably attached to the connection member.

Hereby, it is possible to provide a simple and easily mountable lifting mechanism.

It may be an advantage that the rack is attached to the frame of a yoke by means of a mounting member and a support member that is attached to the distal end of the rack and to the frame of the yoke.

It may be beneficial that the slide member is mounted to slide along the rack.

It may be an advantage to apply an electrical motor that is mounted on the slide member and electrically connected to a control box by means of one or more cables, and that the motor is mounted to drive the pinion.

Hereby, when the electrical motor is activated, the pinion rotates and moves along the longitudinal axis of the rack. Accordingly, the slide member that is slidably attached to the rod member will be displaced along the rod member.

It may be beneficial that the lifting mechanism comprises an arched rack, a pinion, a motor, a slide member and means for being attached to the frame, where the pinion is rotatably attached to the slide member, where the slide member is mounted to slide along the rack, where the electrical motor is mounted on the slide member.

It may be advantageous that the pinion is mechanically attached to and configured to be driven by an electrical motor.

It may be an advantage that the lifting member is rotatably attached to the slide member by means of a pin joint.

It may be advantageous that an aperture or a bore is provided in the lifting member, and that the aperture or the bore is configured to receive a wire or a hook member mechanically connected to the wire.

It may be an advantage that the lifting mechanism comprises a first connection member rotatably attached to the lifting member and rotatably attached to a member that is translated upon activation of the drive means.

Hereby, it is possible to transform a linear motion to an arched motion in an easy and reliable manner.

It may be advantageous that the lifting mechanism comprises a second connection member rotably attached to the first connection member and being rotatably attached to the frame or comprising means for being rotably attached to the frame.

This construction provides an ideal movement path for the lifting member. It is preferred that the point at which the second connection member is attached to the frame is provided in a distance significantly shorter than the distance from the point at which the second connection member is attached to the first connection member, and the point at which the first connection member is attached to the member that is translated upon activation of the drive means.

It may be beneficial that the second connection member is significantly shorter than the first connection member.

It may be advantageous that the lifting mechanism comprises a lifting member rotatably attached to a connection member of the lifting mechanism.

Hereby, the lifting mechanism can be suspended in a single point arranged at the lifting member and still be fully operable.

It may be an advantage that the lifting point is arranged within the circumference of the lifting mechanism.

Hereby, the size of the lifting mechanism can be minimised.

It may be beneficial that the lifting mechanism comprises a frame and that the lifting point is arranged within the circumference of the frame. By the term within the “circumference of frame” is meant within the periphery of the frame.

Hereby, it is possible to provide a compact lifting mechanism.

The object of the present invention may be achieved by a lifting device such as a C-yoke having a lifting mechanism according to the invention.

It may be an advantage that the C-yoke comprises a weight member removably attached to the frame.

Hereby, it is possible to change the centre of gravity of the system that includes the C-yoke, the load (e.g. a wind turbine blade) and the lifting mechanism. Hereby, it is possible to apply the same lifting mechanism to handle different types of loads.

### DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1 a) shows a schematic side view of a lifting mechanism according to the invention mounted on a yoke;

FIG. 1 b) shows a schematic side view of the lifting mechanism shown in FIG. 1 a); however, in another configuration;

FIG. 1 c) shows a schematic side view of the lifting mechanism shown in FIG. 1 a) and FIG. 1 b) in yet another configuration;

FIG. 2 a) shows a schematic side view of a lifting mechanism according to the invention mounted on a C-yoke that is configured to handle a wind turbine blade;

FIG. 2 b) shows a schematic side view of the movement path and the forces applied during usage of the lifting mechanism shown in FIG. 2 a);

FIG. 3 shows a schematic side view of a lifting mechanism according to the invention mounted on a yoke configured to handle a cylindrical load;

FIG. 4 shows a schematic side view of another lifting mechanism according to the invention mounted on a yoke configured to handle a cylindrical load;

FIG. 5 shows a schematic side view of a lifting mechanism according to the invention mounted on a yoke configured to handle an elongated load;

FIG. 6 a) shows a schematic side view of a lifting mechanism according to the invention and

FIG. 6 b) shows a schematic side view of another lifting mechanism according to the invention.

### DETAILED DESCRIPTION OF THE INVENTION

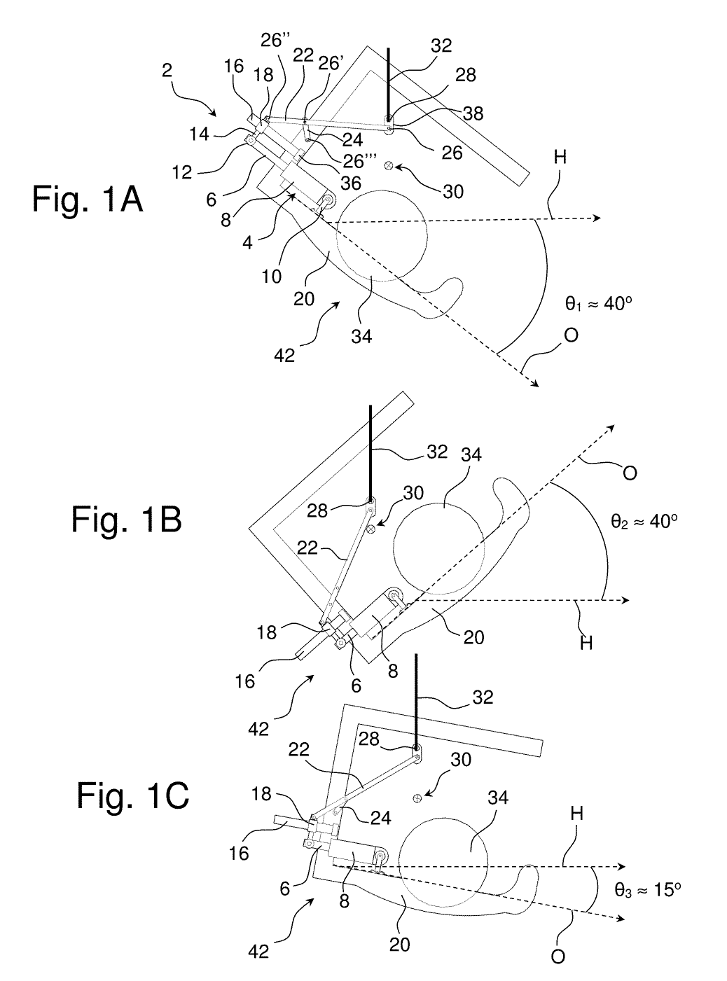

Referring now in detail to the drawings for the purpose of illustrating preferred embodiments of the present invention, different states of operation of the lifting mechanism 2 of the present invention are illustrated in FIG. 1.

FIG. 1 a) illustrates a schematic side view of a lifting mechanism 2 according to the invention mounted on a yoke 42.

The lifting mechanism 2 comprises drive means 4 provided as an actuator 4 with a housing 8 and a rod member 6. The lifting mechanism 2 comprises an attachment member 12 fixed to a connection member 14 that is mechanically attached to a slide member 18 slidably attached to a rod member 16 extending parallel to the rod member 6 of the actuator 4.

The rod member 16 is attached to the frame 20 of the yoke 42 by means of a mounting member 36. The housing 8 of the actuator 4 is attached to the frame 20 of the yoke 42 by means of a mounting member 10.

An elongated connection member 22 is rotatably attached to the slide member 18 by means of a pin joint 26″. The connection member 22 is rotatably attached to a lifting member 38 by means of a pin joint 26. A smaller connection member 24 is rotatably attached to the frame 20 of the yoke 42 by means of a pin joint 26′″, and is rotatably attached to the connection member 22 by means of a pin joint 26′.

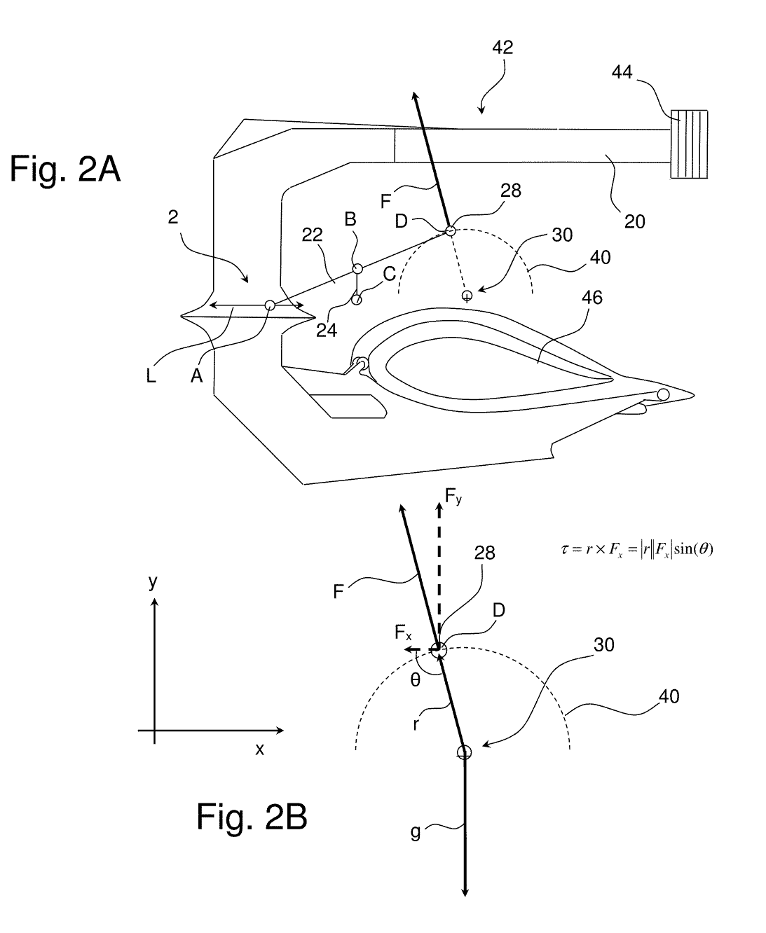

The lifting member 38 is moved in a specific movement path (see FIG. 2 b) when the actuator 4 is activated. Activation of the actuator 4 will cause translation of the slide member 18 which will displace the connection member 22. This will cause a change of position of the lifting member 38 relative to the yoke 42. Hereby, the position of the lifting point 28 is moved relative to the centre of gravity 30 of the system (where the system is considered to include the lifting mechanism 2, the yoke 42 and the load 34).

A load 34 is held by the yoke 42. The load 34 is arranged within a load groove of the frame 20 of the yoke 42.

A wire 32 is attached to the lifting member 38, and a lifting apparatus such as a crane may be connected to the wire 32. The wire 32 extends vertically.

The horizontal direction H as well as the direction of orientation O of the yoke 42 are indicated on FIG. 1 a). It can be seen that the angle θ₁ between horizontal H and the direction of orientation O of the yoke 42 is approximately 40 degrees. The yoke 42 has been pitched about 40 degrees clockwise relative to horizontal H.

The lifting point 28 and the centre of gravity 30 are provided along the same vertical line. Accordingly, the torque induced by the resulting force (the sum of gravity and the force F) is zero.

The rod member 6 is extended close to its maximum length, and accordingly, the slide member 18 is arranged close to the distal end of the rod member 16.

FIG. 1 b) shows a schematic side view of the lifting mechanism shown in FIG. 1 a) in a configuration in which the yoke 42 has been pitched approximately 40 degrees anticlockwise relative to horizontal H. Accordingly, the angle θ₂ between horizontal H and the direction of orientation O of the yoke 42 is approximately 40 degrees. The wire 32 extends vertically, and the lifting point 28 and the centre of gravity 30 are provided along the same vertical line. Consequently, the torque induced by the resulting force (the sum of gravity and the force F) is zero.

By activating the actuator 4, the rod member 6 can be erected and retracted in very limited space. In FIG. 1 b), the lifting mechanism is used to reverse the actuator 4. Accordingly, the rod member 6 is retracted. The rod member 6 is hereby shortened close to its minimum length. Accordingly, the slide member 18 is arranged closed to the housing 8 of the actuator 4.

The elongated connection member 22 and the smaller connection member 24 extend parallel to each other in this state of operation. As a consequence, the smaller connection member 24 is not visible since it is hidden behind the elongated connection member 22.

FIG. 1 c) shows a schematic side view of the lifting mechanism shown in FIG. 1 a) and FIG. 1 b) in another state of operation. In this configuration, the yoke 42 has been pitched 15 degrees clockwise relative to horizontal H. Thus, the angle θ₃ between horizontal H and the direction of orientation O of the yoke 42 is approximately 15 degrees.

The wire 32 extends vertically. Therefore, the lifting point 28 and the centre of gravity 30 are provided along the same vertical line. Accordingly, the torque induced by the resulting force (the sum of gravity and the force F) is zero.

The actuator 4 has been activated and the rod member 6 is brought into a position in which its length is longer than shown in FIG. 1 b) but shorter than shown in FIG. 1 a).

The elongated connection member 22 is angled slightly relative to the smaller connection member 24.

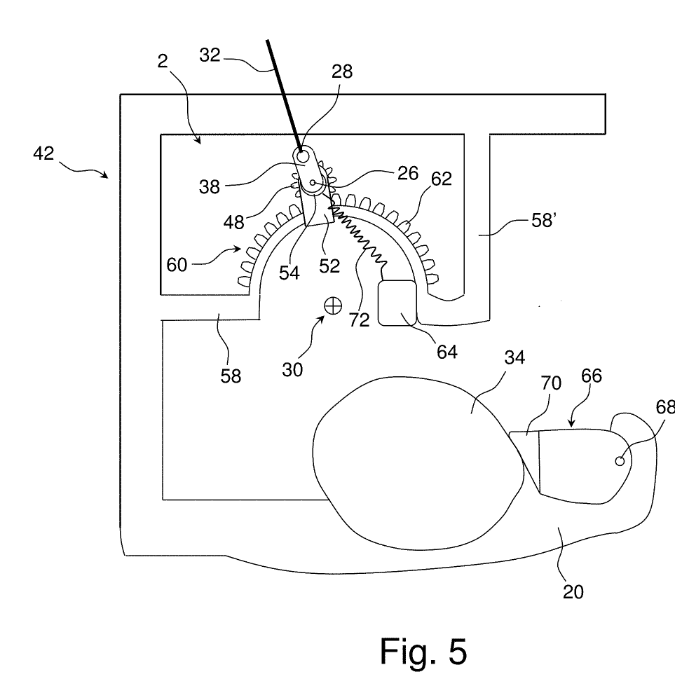

Although not shown in FIG. 1 a), FIG. 1 b) and FIG. 1 c), the yoke 42 may be equipped with locking means for securing the load 34 to the frame 20 of the yoke 42. Hereby, the load 34 can be held in place during the pitching action by means of the locking means. An example of such locking means is, however, shown in FIG. 5.

FIG. 2 a) shows a schematic side view of a lifting mechanism 2 according to the invention mounted on a C-yoke 42 configured to handle a wind turbine blade 46.

The C-yoke 42 comprises a frame 20 and a weight member 44 removably attached to the frame 20. Accordingly, it is possible to change the centre of gravity 30 of the system including the C-yoke, the wind turbine blade 46 (the load) and the lifting mechanism 2. Hereby, it is possible to apply the same lifting mechanism to handle different types of loads.

FIG. 2 a) shows a schematic view of the structural elements of the lifting mechanism 2. The lifting mechanism 2 comprises a first point A that is slidably arranged to be moved along a line L. Any suitable type of actuator (e.g. a linear electrical actuator) may be applied to establish the motion of point A along the line L.

The lifting mechanism 2 further comprises a point B representing a joint and a point D corresponding to the lifting point 28 of the lifting mechanism 2. The lifting mechanism 2 moreover comprises an elongated connection member 22 that mechanically connects the points A, B, D, and a shorter connection member 24 that is rotatably attached to the joint at point C and rotatably attached to the elongated connection member 22 at point B. Although not shown, point C may be attached directly or indirectly to the frame 20 of the yoke 42.

When the point A is moved along the line L, the point D is moved in an arched movement path 40 indicated with a dotted line. The system comprising: the yoke 42, the lifting mechanism 2 and the wind turbine blade 46 has a centre of gravity 30.

When the lifting mechanism is activated, and the point D is provided at a specific position along the movement path 40, a torque will be initiated due to gravity, and the system will be rotated about its centre of gravity 30. Hereby, an equilibrium in which the lifting point 28 will be arranged along the same vertical line as the centre of gravity 30 is established. When the equilibrium is established, the torque induced by the resulting force (the sum of gravity and the force F) is zero, and no rotation of the frame 20 of the yoke 42 will be created.

FIG. 2 b) illustrates a schematic side view of the movement path 40 and the forces F, g applied during usage of the lifting mechanism 2 shown in FIG. 2 a).

A two-dimensional coordinate system with a horizontal axis x and a vertical axis y is illustrated in the left part of FIG. 2 b).

The movement path 40 is a circular arc indicated with a dotted line. Gravity g extends along the vertical axis y and acts on the centre of gravity 30. The lever-arm distance vector r from the centre of gravity 30 to the lifting point 28 (also indicated with D) is indicated in FIG. 2 b).

The vertical component F_{y} and the horizontal component Fₓ of the lifting force F are indicated with dotted arrows, while the lifting force F is indicated with a solid arrow. Furthermore, the angle θ between the lifting force F and the lever-arm distance vector r is indicated on FIG. 2 b).

Further, the torque τ is expressed by the following equation:

τ=r×Fₓ=|r∥Fₓ|sin(θ) (1)

where r×F is the cross product between the lever-arm distance vector r and the horizontal component Fₓ of the lifting force F (since the vertical component F_{y} of the lifting force F and gravity g will cancel out each other, Fₓ corresponds to the resulting force).

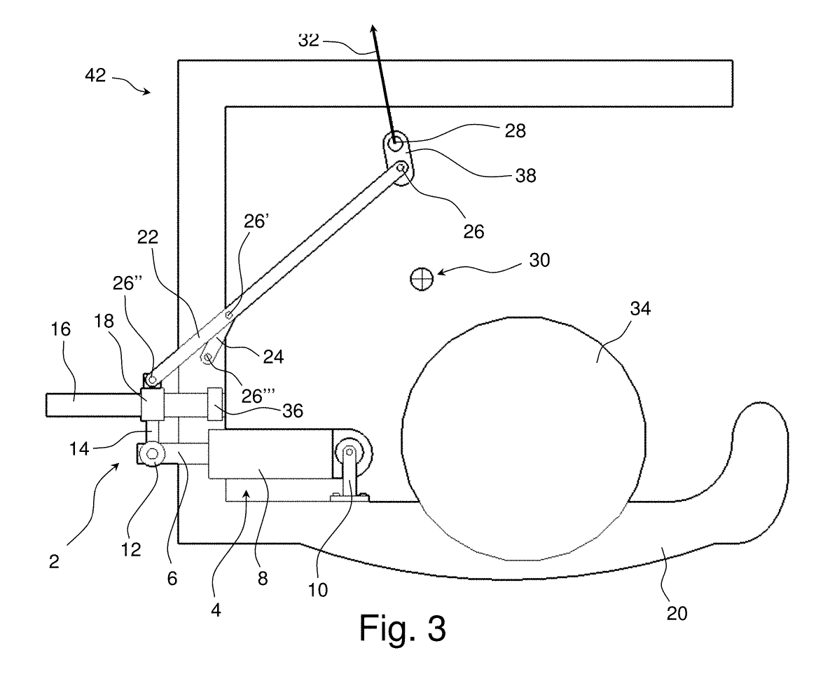

FIG. 3 illustrates a schematic side view of a lifting mechanism 2 according to the invention mounted on a yoke 42 configured to handle a cylindrical load 34.

The yoke 42 comprises a frame 20 provided with a groove configured to receive a load 34. The lifting mechanism 2 comprises an actuator 4 attached to the frame 20 of the yoke 42. The actuator 4 has a housing 8 and a rod member 6. Attachment member 12 is fixed to the rod member 6 and to a connection member 14 that is mechanically attached to a slide member 18 slidably attached to a further rod member 16 extending parallel to the rod member 6 of the actuator 4.

The rod member 16 is fixed to the frame 20 of the yoke 42 by means of a mounting member 36 that is mechanically attached to the frame 20 of the yoke 42. The housing 8 is fixed to the frame 20 of the yoke 42 by means of a mounting member 10.

An elongated connection member 22 is rotatably attached to the slide member 18 by means of a pin joint 26″, while the connection member 22 is rotatably attached to a lifting member 38 by means of a pin joint 26. A smaller connection member 24 is rotatably attached to the frame 20 of the yoke 42 by means of a pin joint 26′″ and rotatably attached to the connection member 22 by means of a pin joint 26′.

When the actuator 4 is actuated, the slide member 18 is moved along the rod member 16. This causes displacement of the connection member 22 resulting in a change of position of the lifting member 38 relative to the yoke 42. Hereby, the position of the lifting point 28 is moved relative to the centre of gravity 30 of the system, which system includes the lifting mechanism 2, the yoke 42 and the load 34.

A wire 32 is attached to the lifting member 38. Any suitable lifting apparatus e.g. a crane can be mechanically attached to the wire 32 in order to lift and/or pitch the yoke 42.

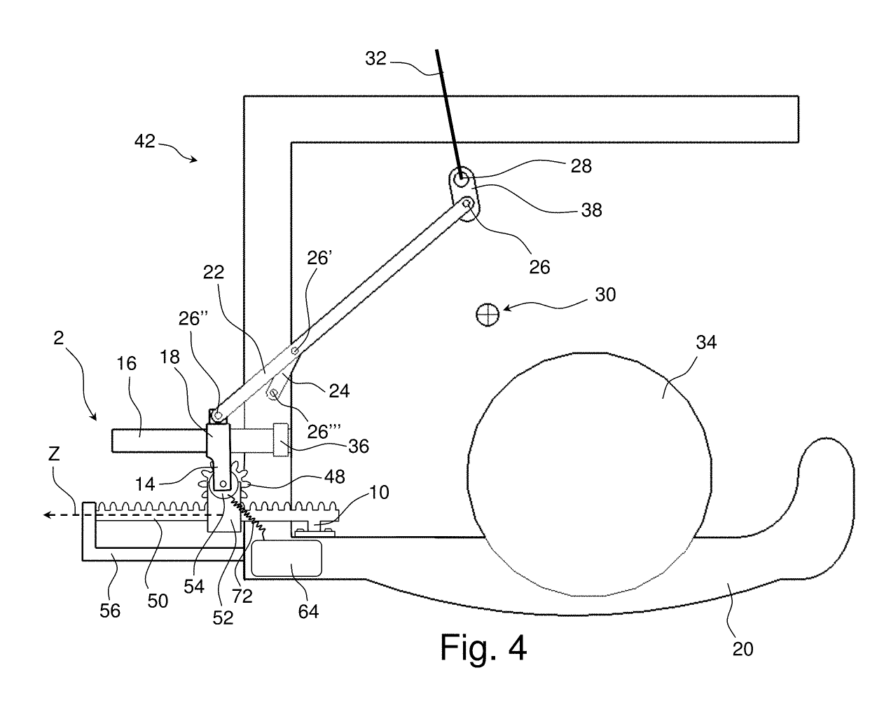

FIG. 4 illustrates a schematic side view of a lifting mechanism 2 according to the invention. The lifting mechanism 2 is mounted on a yoke 42 configured to handle a load 34.

The lifting mechanism 2 comprises a rack 50 provided with a plurality of teeth configured to engage with the teeth of a pinion 48 rotatably attached to a connection member 14. The rack 50 is attached to the frame 20 of the yoke 42 by means of a mounting member 10 and a support member 56 attached to the distal end of the rack 50 and to the frame 20 of the yoke 42.

A slide member 52 is mounted to slide along the rack 50. An electrical motor 54 is mounted on the slide member 52 and electrically connected to a control box 64 by means of a cable 72.

When the electrical motor 54 is activated, the pinion 48 rotates and moves along the longitudinal axis Z of the rack 50. Accordingly, the slide member 18, which is slidably attached to the rod member 16, will be displaced along the rod member 16.

The movement of the slide member 18 changes the orientation of the connection member 22, which is rotatably attached to the slide member 18, to a smaller connection member 24 and to a lifting member 38 by means of a pin joint 26. The small connection member 24 is rotatably connected to the frame 20 of the yoke 42 by means of a pin joint 26′″ and rotatably connected to the elongated connection member 22 by means of a pin joint 26′. Consequently, activation of the motor 54 causes movement of the slide member 18. This will result in a position change of the lifting member 38.

When the position of the lifting member 38 is changed, it is possible to introduce a torque like explained with reference to FIG. 2 a) and FIG. 2 b). A wire 32 is attached to an aperture provided in the lifting member 38. The lifting point 28 is indicated in FIG. 4.

The size and number of teeth on the rack 50 and the corresponding pinion 48 may be varied in various ways. It may be an advantage to apply a larger number of teeth of a smaller size than shown in FIG. 4.

The control box 64 may be controlled by a wireless remote control (not shown) of any suitable type.

FIG. 5 illustrates a schematic side view of a lifting mechanism 2 according to the invention mounted on a yoke 42 configured to handle an elongated load 34.

The frame 20 is provided with a groove member configured to receive a load 34. The geometry of the groove member may be adapted to fit the outer geometry of the load 34.

A locking member 66 is rotatably attached to the lower and distal end of the frame 20 by means of a joint 68. The locking member 66 comprises a resilient member provided at its distal end. The resilient member is configured to bear against (or abut) the load 34 and hereby fix the load 34.

The lifting mechanism 2 comprises an arched rack 60 provided with a plurality of teeth 62 evenly distributed along the arched rack 60. A pinion 48 provided with a plurality of teeth configured to engage with the teeth 62 of the arched rack 60 is movably attached to the arched rack 60 by means of a slide member 52.

The pinion 48 is mechanically attached to an electrical motor 54 and configured to be driven by the electrical motor 54. A lifting member 38 is rotatably attached to the slide member 52 by means of a pin joint 26. An aperture is provided in the lifting member 38, and a wire 32 is attached to the aperture of the lifting member 38. The point at which the wire 32 is attached corresponds to the lifting point 28.

The arched rack 60 is attached to the frame 20 of the yoke 42 by means of a first support member 58 and a second support member 58′.

A control box 64 is attached to the second support member 58′ and electrically connected to the motor 54 by means of a cable 72. Since the lifting point 28 is horizontally displaced relative to the centre of gravity 30, a torque (not shown) will be induced, and a clockwise rotation of the yoke 42 will be provided. When the lifting point 28 and the centre of gravity 30 are arranged along the same vertical line, the torque will be zero.

When the motor 54 is activated, the slide member 52 and thus the lifting member 38 and the lifting point 28 will be moved along the rack 60. The position of the lifting member 38 determines the magnitude and direction of the torque introduced (use equation (1) like explained with reference to FIG. 2 b). Accordingly, it is possible to pitch the yoke 42 in a controlled manner by means of the lifting mechanism 2.

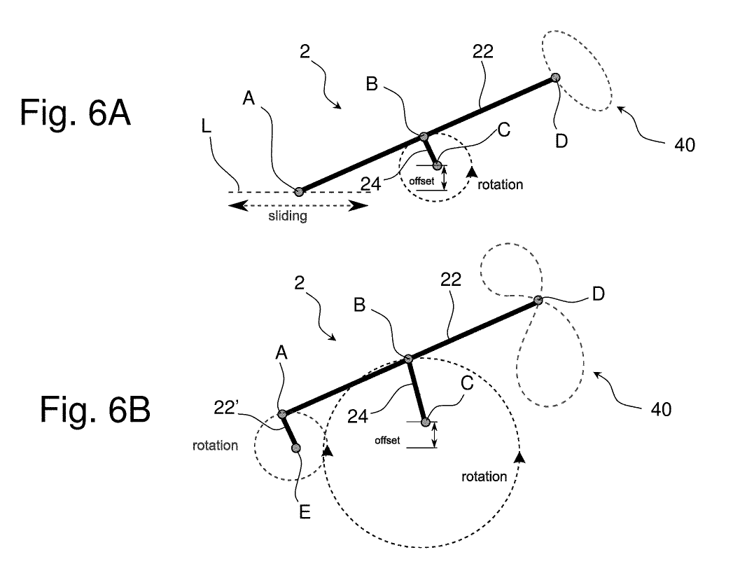

FIG. 6 a) illustrates a schematic side view of a lifting mechanism 2 according to the invention. The lifting mechanism 2 basically corresponds to the one shown in FIG. 2 a); however, the point C is slidably arranged causing a slightly different movement path 40.

The lifting mechanism 2 comprises a first point A slidably arranged to be moved along a line L. Any suitable type of actuator (such as a linear electrical actuator) may be applied to provide the motion of point A along the line L.

The lifting mechanism 2 comprises a point B representing a joint and a point D corresponding to the lifting point of the lifting mechanism 2. The lifting mechanism 2 further comprises an elongated connection member 22 that mechanically connects the points A, B, D and a connection member 24 rotatably attached to the joint at point C. The connection member 24 is rotatably attached to the elongated connection member 22 at point B. The point C is slidably arranged allowing an offset as indicated to be provided.

When the point A is moved along the line L, the point D is moved in an arched movement path 40 indicated with a dotted line.

When the lifting mechanism is activated the point D is provided at a specific position along the movement path 40. When the points A and C are provided along the line L, the movement path 40 will be circular. However, when the point C is offset (and thus the points A and C are not provided along the line L), the movement path 40 will be an elliptic curve as shown in FIG. 6 a).

FIG. 6 b) illustrates a schematic side view of another lifting mechanism 2 according to the invention. The lifting mechanism 2 comprises a first point A rotatably arranged about a point E, wherein a connection member 22′ connects the two points A, E.

The lifting mechanism 2 further comprises a point B representing a joint and a point D corresponding to the lifting point of the lifting mechanism 2. The lifting mechanism 2 moreover comprises an elongated connection member 22 connecting the points A, B, D. The lifting mechanism 2 further comprises a connection member 24 rotatably attached to the joint at point C. The connection member 24 is rotatably attached to the elongated connection member 22 at point B. The point C is slidably arranged allowing an offset as indicated to be provided.

By rotating the point B along the large circular patch indicated by the dotted line and by rotating the point A along the small circular patch indicated, it is possible to achieve the indicated movement path 40 shown in FIG. 6 b).

The movement path 40 can be varied in many ways by selecting different offsets. Accordingly, it is possible to achieve a movement path 40 adapted to meet specific requirements.

In the embodiments illustrated in FIG. 1-FIG. 6, it is possible to apply several lifting mechanisms 2. The lifting mechanisms 2 may be configured to act independently of each other. Hereby, it is possible to perform rotations about several axes at the same time.

The lifting mechanism 2 according to the invention may be mounted on various types of lifting equipment including yokes and C-yokes of various shapes, types and sizes.

One way to install the blades to a wind turbine rotor is to attach the first blade to the rotor on the ground and then install the rotor with a rotor lift. Subsequently, the second blade needs to be installed while being tilted 30° relative to horizontal. The third blade may be installed while being tilted −30° relative to horizontal. The lifting mechanism 2 and the lifting device 42 according to the invention are capable of performing such installations in an easy and secure manner.

### LIST OF REFERENCE NUMERALS

2 Lifting mechanism
4 Actuator
6 Rod member
8 Housing
10 Mounting member
12 Attachment member
14 Connection member
16 Rod member
18 Slide member
20 Frame
22, 22′, 24 Connection member
26, 26′, 26″, 26′″ Joint member
28 Lifting point
30 Centre of gravity
32 Wire
34 Load
36 Mounting member
38 Lifting member
40 Movement path
42 Yoke
44 Weight member
46 Wind turbine blade
48 Pinion
50 Rack
52 Slide member
54 Motor
56, 58, 58′ Support member
60 Arched rack
62 Tooth
64 Control box
66 Locking member
68 Joint
70 Resilient member
72 Cable
F Force
H Horizontal
O Direction of orientation
x x-axis
y y-axis
Z Longitudinal axis
r Lever-arm distance vector
θ, θ₁, θ₂, θ₃ Angle
A, B, C, D, E Point
τ Torque
g Gravity
L Line

1. A lifting mechanism for lifting an object comprising a drive capable of being attached to a frame of a lifting device, the lifting mechanism further comprises a lifting member connectable to a wire, wherein the lifting mechanism is configured for moving the lifting member in an arced or curved movement path relative to the frame when the lifting mechanism is attached to the frame, wherein the lifting mechanism is configured to be suspended in only one lifting point.

2. The lifting mechanism of claim 1, wherein the drive is mechanically connected to the lifting member in such a manner that the lifting member upon activation of the drive is moved in an arched or curved movement path relative to the frame when the lifting mechanism is attached to the frame.

3. The lifting mechanism of claim 1, wherein the lifting mechanism comprises means for, upon activation of the drive, moving the lifting member along an arched or curved movement path relative to the frame, when the lifting mechanism is attached to the frame.

4. The lifting mechanism of claim 2, wherein the lifting mechanism comprises a rod member, a slide member, an attachment member, a connection member and an actuator having a rod, where the attachment member is fixed to the connection member that is mechanically attached to the slide member being slidably attached to the rod member extending approximately parallel to the rod of the actuator.

5. The lifting mechanism of claim 2, wherein the lifting mechanism further comprises a rack, a pinion and a connection member, where the rack is provided with a plurality of teeth configured to engage with the teeth of the pinion that is rotatably attached to the connection member.

6. The lifting mechanism of claim 2, wherein the lifting mechanism comprises an arched rack, a pinion, a motor, a slide member and means for being attached to the frame, where the pinion is rotatably attached to the slide member, where the slide member is mounted to slide along the rack and where the electrical motor is mounted on the slide member.

7. The lifting mechanism of claim 1, wherein the lifting mechanism comprises a first connection member rotatably attached to the lifting member and rotatably attached to a member that is translated upon activation of the drive

8. The lifting mechanism of claim 7, wherein the lifting mechanism comprises a second connection member rotatably attached to the first connection member and attached to the frame or capable of being rotatably attached to the frame.

9. The lifting mechanism of claim 1, wherein the lifting mechanism comprises a lifting member rotatably attached to a connection member of the lifting mechanism.

10. The lifting mechanism of claim 1, wherein the lifting point is arranged within a circumference of the lifting mechanism.

11. The lifting mechanism of claim 10, wherein the lifting point is positioned within the circumference of the frame.

12. A C-yoke lifting device having a lifting mechanism of claim 1.

13. The lifting device of claim 12, wherein the C-yoke comprises a weight member removably attached to the frame.

14. A lifting mechanism for lifting an object, comprising drive means comprising means for being attached to a frame of a lifting device, which lifting mechanism further comprises a lifting member provided with means for being connected to a wire, wherein the lifting mechanism comprises means for moving the lifting member in an arced or curved movement path relative to the frame when the lifting mechanism is attached to the frame, wherein the lifting mechanism is configured to be suspended in only one lifting point.

15. A lifting mechanism according to claim 14, wherein the lifting mechanism comprises mechanical connection means between the drive means and the lifting member in such a manner that the lifting member upon activation of the drive means is moved in an arched or curved movement path relative to the frame when the lifting mechanism is attached to the frame.

16. The lifting mechanism of claim 14, wherein the lifting mechanism comprises means for upon activation of the drive means moving the lifting member along an arched or curved movement path relative to the frame, when the lifting mechanism is attached to the frame.

17. The lifting mechanism of claim 15, wherein the lifting mechanism comprises a rod member, a slide member, an attachment member, a connection member and an actuator having a rod member, where the attachment member is fixed to the connection member that is mechanically attached to the slide member being slidably attached to the rod member extending basically parallel to the rod member of the actuator.

18. The lifting mechanism of claim 14, wherein the lifting mechanism comprises a rack, a pinion and a connection member, where the rack is provided with a plurality of teeth configured to engage with the teeth of the pinion that is rotatably attached to the connection member.

19. The lifting mechanism of claim 15, wherein the lifting mechanism comprises an arched rack, a pinion, a motor, a slide member and means for being attached to the frame, where the pinion is rotatably attached to the slide member, where the slide member is mounted to slide along the rack and where the electrical motor is mounted on the slide member.

20. The lifting mechanism of claim 14, wherein the lifting mechanism comprises a first connection member rotatably attached to the lifting member and rotatably attached to a member that is translated upon activation of the drive means.
